(19) United States
(12) Patent Application Publication
(10) Pub. No.: US 2009/0290104 A1
(43) Pub. Date: Nov. 26, 2009

(54) COMPOSITE POLARIZING PLATE, METHOD FOR PRODUCING THE SAME, COMPOSITE OPTICAL MEMBER AND LIQUID CRYSTAL DISPLAY

(75) Inventors: Norimasa Nakagawa, Ehime (JP); Yoshiki Matsuoka, Ehime (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, TOKYO (JP)

(21) Appl. No.: 12/373,062

(22) PCT Filed: Jul. 12, 2007
(86) PCT No.: PCT/JP07/64298

§ 371 Date: Jan. 9, 2009

(30) Foreign Application Priority Data
Jul. 18, 2006 (JP) 2006-195231
Jul. 19, 2006 (JP) 2006-196530

(51) Int. Cl. G02F 1/1335; C09K 19/52; B32B 37/00

(52) U.S. Cl. 349/96; 428/1.31; 156/60

(57) ABSTRACT

Disclosed is a composite polarizing plate (10)wherein a transparent protection film (12) is bonded to one side of a polarizer (11), and a transparent resin film (13), a primer layer (14) and a coating retardation layer (15) containing an organic modified clay composite and a binder resin are formed on the other side of the polarizer (11) in this order. This composite polarizing plate is produced by a process comprising a step for forming the primer layer (14) on the surface of the transparent resin film (13), a step for forming the coating retardation layer (15) on the surface of the primer layer (14), and a step for bonding the transparent protection film (12) to one side of the polaizer (11) and bonding the transparent resin film (13) provided with the coating retardation layer (15) to the other side of the polarizer (11) with the transparent resin film (13) side facing the polarizer, respectively using an adhesive.

### TECHNICAL FIELD

The present invention relates to a composite polarizing plate to be used by pasting to a liquid crystal cell, a method for producing the same, a composite optical member using this composite polarizing plate, and a liquid crystal display.

### BACKGROUND ART

In recent years, use of liquid crystal displays has been rapidly expanding as devices for displaying information, such as cellular phones, portable information terminals, computer monitors and television sets, due to their characteristics, such as low power consumption, low operation voltage, light weight and thinness. Together with development of liquid crystal technology, various modes of liquid crystal displays have been proposed, and problems with speed of response, contrast, narrow viewing angle and the like have been solved.

However, as is still pointed out, the viewing angle is narrower than that of cathode ray tubes (CRT), and various attempts have been made to expand the view angle.

One of such a liquid crystal display is a vertical alignment (VA) modee liquid crystal display where liquid crystal molecules in rod form having anisotropy with a positive or negative dielectric constant are oriented perpendicular to the substrate. In such a vertical alignment mode, liquid crystal molecules are oriented perpendicular to the substrate in a non-drive state, and therefore, light passes through a liquid crystal layer without a polarity change. For this reason, when linear polarizing plates are provided on the top and bottom of a liquid crystal panel so that polarizing axes cross at a right angle, an almost completely black display can be gained as viewed from the front, and thus, a high contrast ratio can be gained.

However, in VA mode liquid crystal displays where only polarizing plates are provided to a liquid crystal cell, the axial angle of the provided polarizing plates shifts from 90° as viewed diagonally, and the liquid crystal molecules in rod form within the cell exhibit birefringence, which causes light to leak and makes the contrast ratio significantly lower.

In order to prevent light from leaking, it is necessary to provide an optical compensation film between the liquid crystal cell and the linear polarizing plates, and conventionally, a specification where a biaxial retardation plate is provided between the liquid crystal cell and the upper polarizing plate, as well as the lower polarizing plate, respectively, and a specification where a positive uniaxial retardation plate and a completely biaxial retardation plate are provided over and beneath the liquid crystal cell, respectively, or the two plates are provided on one side of the liquid crystal cell, have been adopted.

For example, Patent Document 1 describes that an a-plate (that is, a positive uniaxial retardation plate) and a c-plate (that is, a completely biaxial plate) are provided between upper and lower polarizing plates and the liquid crystal cell, respectively (claim 15 and paragraph 0036).

The positive uniaxial retardation plate is a film where the ratio R0/Rth of the retardation value R0 in a plane to the retardation value Rth in the thickness direction is approximately 2, and the completely biaxial retardation plate is a film where the retardation value R0 in a plane is approximately 0. Here, the retardation value R0 in a plane and the retardation value Rth in the thickness direction can be defined by the following formulas (I) and (II), respectively, when the index of refraction along the in-plane slow axis of the film is nx, the index of refraction of the film along the in-plane fast axis of the film (in the direction perpendicular to the in-plane slow axis) is fy, the index of refraction in the thickness direction of the film is nz, and the thickness of the film is d.

R0=(nx−ny)×d (I)

Rth=[(nx+ny)/2−nz] ×d (II)

In positive uniaxial films, nz≈ny, and therefore, R0/Rth ≈2. Even in positive uniaxial films, R0/Rth sometimes changes between approximately 1.8 and 2.2 due to inconsistency in the conditions for stretching. In completely biaxial films, nx≈ny, and therefore, R0≈0. In completely biaxial films, only the index of refraction in the thickness direction is different (small), and therefore, completely biaxial films are referred to a film having negative uniaxiality and an optical axis in the normal direction, and are also referred to as c-plates, as described above.

One of such a completely biaxial film (c-plate) is formed of a coating layer containing an organic modified clay composite. For example, Patent Document 2 discloses a composite polarizing plate where a polarizing plate, a tackifier layer and a retardation plate made of a coating layer having anisotropy in the index of refraction are laminated in this order, and a layer formed of an application liquid containing an organic modified clay composite and a binder resin is cited as an example of the coating layer. As a method for producing this composite polarizing plate, a method is disclosed in which a coating layer is formed on a transcription base material and after that exposed surface of the above described coating layer is laminated on the tackifier layer side of the polarizing plate having the tackifier layer, and then the transcription base material is peeled from the coating layer. Patent Document 3 discloses a composite retardation plate where a coating retardation layer having anisotropy in the index of refraction is laminated on a retardation plate made of a transparent resin film oriented in a plane with a tackifier layer interposed therebetween, and also describes that a polarizing plate is laminated on the resin retardation plate side. In addition, Patent Document 4 discloses a retardation plate where an urethane resin mainly composed of aliphatic diisocyanate is used as a binder and a composition containing this and an organic modified clay composite is formed in a film-state, and also describes that the retardation plate is laminated on a polarizing plate with a tackifier layer interposed therebetween so as to provide a composite polarizing plate. In configurations disclosed in these Patent Document 2 and Patent Document 4, a polarizing plate and a retardation plate made of a coating layer are pasted together with a tackifier layer interposed therebetween, or protective films are provided on the two sides of a polarizer.
Patent Document 1 Japanese Unexamined Patent Publication 2001-109009
Patent Document 2 Japanese Unexamined Patent Publication 2005-309290
Patent Document 3 Japanese Unexamined Patent Publication 2005-338215
Patent Document 4 Japanese Unexamined Patent Publication 2006-10912

The present inventors have found that a thinner composite polarizing plate than in the prior art can be fabricated by forming a coating retardation layer on the surface of a transparent resin film on a polarizing plate with a primer layer interposed therebetween, and pasting this to a polarizer on the transparent resin film side, and at the same time pasting a transparent protective film on the other surface of the polarizer, when a polarizing plate and a coating retardation layer having anisotropy in the index of refraction are laminated so as to forma composite polarizing plate, and thus, the present invention has been achieved. Furthermore, they additionally have found that a thinner composite polarizing plate than in the prior art can be fabricated by using a transparent resin film as a retardation plate and laminating the retardation on the side having no transparent protective film of the above polarizer with an adhesive layer interposed therebetween, and thus the present invention has been achieved.

Accordingly, an object of the present invention is to provide a thinner composite polarizing plate than in the prior art while keeping the optical performance the same as in conventional products, as well as a method for producing the same. Another object of the present invention is to provide a thinner composite optical member than in the prior art by laminating an optical layer exhibiting other optical functions on this composite polarizing plate. Still another object of the present invention is to provide an even thinner liquid crystal display by using these composite polarizing plates or composite optical members.

### DISCLOSURE OF THE INVENTION

The present invention provides a composite polarizing plate where a transparent protective film is pasted on one side of a polarizer and a transparent resin film, a primer layer and a coating retardation layer containing an organic modified clay composite and a binder resin are formed on the other side in this order.

This composite polarizing plate can be produced through the following steps:

a primer layer forming step for providing a primer layer on the surface of a transparent resin film;

a coating retardation layer forming step for applying an application liquid containing an organic modified clay composite and a binder resin in an organic solvent on the surface of the primer layer and forming the coating retardation layer by removing the solvent therefrom; and

aA pasting step for separately preparing a polarizer and a transparent protective film and pasting the transparent protective film on one side of the polarizer with an adhesive layer interposed therebetween and pasting the transparent resin film on which said coating retardation layer is formed on the other side of the polarizer with an adhesive layer interposed therebetween, In addition, the present invention provides a composite optical member where an optical layer exhibiting another optical function is laminated on the above described composite polarizing plate.

Furthermore, the present invention provides a liquid crystal display where the above described composite polarizing plate or the above described composite optical member is provided on at least one side of a liquid crystal cell.

### BRIEF DESCRIPTION OF THE DRAWING

FIG. 1 is a schematic cross sectional diagram showing an example of the layer structure of the composite polarizing plate according to the present invention.

FIG. 2 is a schematic cross sectional diagram illustrating an example of a method for producing a composite polarizing plate divided into each step and used members.

FIG. 3 is a schematic cross sectional diagram showing an example in the case where a composite polarizing plate is produced in roll form.

FIG. 4 is a cross schematic sectional diagram showing an example of the layer structure of a composite optical member.

FIG. 5 is a schematic cross sectional diagram showing the layer structure of the composite polarizing plate fabricated in Comparative Example 1.

FIG. 6 is a schematic cross sectional diagram showing an example of the layer structure of the composite polarizing plate according to another embodiment of the present invention.

FIG. 7 is a schematic cross sectional diagram showing an example of a method for producing the composite polarizing plate shown in FIG. 6 divided into each step and used members.

FIG. 8 is a schematic cross sectional diagram showing an example in the case where the composite polarizing plate shown in FIG. 6 is produced in roll form.

FIG. 9 is a schematic cross sectional diagram showing an example of the layer structure of a composite optical member where the composite polarizing plate shown in FIG. 6 is used.

FIG. 10 is a schematic cross sectional diagram showing the layer structure of the composite polarizing plate fabricated in Comparative Example 2.

### EXPLANATION OF REFERENCE NUMERALS

10 . . . composite polarizing plate
11 . . . polarizer
12 . . . transparent protective film
13 . . . transparent resin film
14 . . . primer layer
15 . . . coating retardation layer
18 . . . tackifier layer
19 . . . film with tackifier
21 . . . transparent resin film with primer layer
23 . . . transparent resin film with coating retardation layer
30 . . roller for feeding out transparent resin film
3 . . . primer layer applicator
33 . . . primer layer drying zone
36. . . coating layer applicator
38 . . . coating layer drying zone
40 . . . roller
50 . . . roller for feeding out transparent protective film
51, 52 . . . adhesive applicator
53, 54 . . . roller for pasting
55 . . . polarizing plate drying zone
57 . . . roller for feeding out film with tackifier
60 . . . roller for product
70 . . . composite optical member
71 . . . optical layer exhibiting other optical function
72 . . . tackifier layer
80 . . . composite polarizing plate of Comparative Example 1
81 . . . polarizer
82 . . . triacetyl cellulose film
83 . . . polarizing plate
84 . . . tackifier layer
85 . . . coating retardation layer
88 . . . tackifier layer
113 . . . adhesive layer
114 . . . film with adhesive
115 . . . retardation plate made of transparent resin
116 . . . primer layer
121 . . . polarizing plate
122 . . . retardation plate with primer layer
123 . . . laminated retardation plate
124 . . . laminated retardation plate with tackifier layer
130 . . . roller for feeding out retardation plate
140 . . . roller for feeding out film with tackifier layer
144 . . . roller for feeding out film with adhesive
146 . . . roller for winding mold release film
150 . . . roller for feeding out polarizing plate
180 . . . composite polarizing plate of Comparative Example 2
185 . . . retardation plate
186 . . . primer layer cl BEST MODE FOR CARRYING OUT THE INVENTION

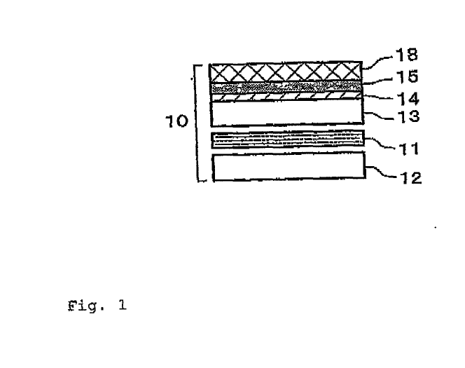

In the following, the embodiments of the present invention are described in detail with reference to the accompanying drawings. FIG. 1 is a schematic cross sectional diagram showing an example of the layer structure of the composite polarizing plate according to the present invention. In the present invention, a transparent protective film 12 is pasted on one side of a polarizer 11 and a transparent resin film 13, a primer layer 14 and a coating retardation layer 15 are formed on the other side in this order, and thus a composite polarizing plate 10 is provided. A tackifier layer 18 for pasting to a liquid crystal cell or the like can be provided outside the coating retardation layer 15.

The polarizer 11 can be a polarizing film made of a conventionally known polyvinyl alcohol based resin. Concretely, a polarizing film where an oriented dichromatic pigment is adsorbed on a polyvinyl alcohol based resin film, and a polyene based orientation film where a polyvinyl alcohol based resin is subjected to a partial dehydration treatment or the like can be cited. Among these, a polyvinyl alcohol based resin film which adsorbs an oriented dichromatic pigment is preferably used. The dichromatic pigment includes iodine based polarizing films where iodine is used and dye-based polarizing films where a dichromatic organic dye is used, and both of them can be used. The thickness of the polarizer 11 is approximately 10 to 50 μm, for example. The polyvinyl alcohol based resin which forms the polarizer 11 can be, in addition to a polyvinyl alcohol which is a saponified polyvinyl acetate, such as polyvinyl butyral, polyvinyl acetal, polyvinyl formal and poly(ethylene-vinyl acetate) saponified copolymers gained by modifying a polyvinyl alcohol with an aldehyde, for example.

The transparent protective film 12 and the transparent resin film 13 to be pasted on both sides of the polarizer 11 may be generally known protective films for polarizing plates, and films made of a cellulose based resin, such as triacetyl cellulose, diacetyl cellulose and cellulose acetate butyrate, films made of a polyolefin based resin which is a polymer of which the main monomer is an olefin, such as propylene or ethylene, films made of a cyclic polyolefin based resin which is a polymer of which the main monomer is a polycyclic olefin, such as norbornene, and films made of a polyester, such as polyethylene terephthalate, in addition to films made of such as polyether sulfone, an acryl based resin, polyurethane, polycarbonate, polysulfone, polyether, polymethyl pentane, polyether ketone or (meth)acrylonitrile can be used. Among these, films made of a cellulose based resin and films made of a polyolefin based resin can be cited as preferable examples. Triacetyl cellulose films, among cellulose resin based films, have excellent optical transparency and can be effective protective layers when laminated on a polarizer, and therefore, are one type of preferable film.

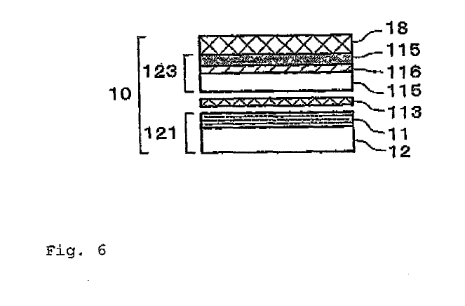

The above described transparent resin film 13 may be a resin retardation plate 115 having a retardation function (FIG. 6) The resin retardation plate 115 is made of a transparent resin, and generally formed so as to be oriented in a plane. Any uniform resin having excellent transparency may be used for the film, but stretched films of a transparent thermoplastic resin is preferably used, from the viewpoint of ease in production for films having orientation. Polyolefin based resins which are polymers of which the main monomer is an olefin, such as polycarbonate, polyacrylate, polysulfone, polyether sulfone, a cellulose based resin, propylene or ethylene, and cyclic polyolefin based resins which are polymers of which the main monomer is a polycyclic olefin, such as norbornene, can be cited as concrete examples of thermoplastic resins. In addition, transparent resin substrates, such as the above described cellulose based resins, provided with an application layer made of a liquid crystal material or the like to express retardation can also be used as the resin retardation plate 115.

An appropriate value within a range of approximately 30 nm to 300 nm may be selected for the in-plane retardation value of the resin retardation plate 115 in accordance with the application of the composite polarizing plate. In the case where the composite polarizing plate is applied to a relatively compact liquid crystal display, such as for a cellular phone or a portable information terminal, for example, it is advantageous that the resin retardation plate 115 is a ¼ wavelength plate.

The transparent protective film 12 and the transparent resin film 13 have a thickness of, for example, approximately 10 to 200 μm, respectively. In addition, various types of surface treating layers, such as reflection preventing layers and glare proof layers, may be provided on the surface of the transparent protective film 12.

In the case where at least the transparent protective film 12 or the transparent resin film 13 is formed of a cellulose based resin, such as triacetyl cellulose, it is preferable that a saponification treatment is carried out on the surface of the transparent protective film 12 pasted to the polarizer 11, the surface of the transparent resin film 13 on which a primer layer 14 is formed and the surface pasted to the polarizer 11. The saponification treatment is generally carried out by immersing the film in an alkali solution.

The primer layer 14 and the coating retardation layer 15 are formed on the surface of the transparent resin 13 in this order. It is advantageous that the primer layer 14 is formed of a transparent resin through application. In general, “primer” means a base coating, and the primer layer 14 in the present invention functions as a base coating layer for the retardation layer 15 formed through coating. In addition, in the case where an application liquid for the coating retardation layer 15 is applied, the presence of a primer layer 14 can prevent the transparent resin film 13 from being affected by an organic solvent in the application liquid. The primer layer 14 is formed of a resin having elasticity, though not so much as the tackifier. Though the type of the resin is not particularly limited, resins which are excellent in application property and have excellent transparency and adhesion, particularly after the formation of a layer, are preferable.

The resin for forming the primer layer 14 may be used in such a state as to be solved in a solvent, or the resin may be diluted with a solvent in order to adjust the film thickness, though the resin itself can be used to form a layer. Any general organic solvent, such as aromatic hydrocarbons, such as benzene, toluene or xylene, ketones, such as acetone, methyl ethyl ketone or methyl isobutyl ketone, esters, such as ethyl acetate or isobutyl acetate, chlorinated hydrocarbons, such as methylene chloride, trichloroethylene or chloroform, and alcohols, such as ethanol, 1-propanol, 2-propanol or 1-butanol, can be used in accordance with the solubility of the resin. In addition, in the case of a water soluble resin, water can be used as a solvent.

Epoxy resins can be cited as preferable examples of the resin forming the primer layer 14. Either a one-component curing type resin or a two-component curing type resin can be used. In addition, a water soluble epoxy resin is particularly preferable. Examples of water soluble epoxy resins are polyamide epoxy resins gained by making epichlorohydrin react with a polyamide polyamine gained as a result of reaction between a polyalkylene polyamine, such as diethylenetriamine or triethylenetetraamine, and a dicarboxylic acid, such as adipic acid. Commercially available products of such polyamide epoxy resins include “Sumirez Resin 650 (30)” and “Sumirez Resin 675,” (both trade names) sold by Sumika Chemtex Co., Ltd.

In the case where a water soluble epoxy resin is used as a resin for forming the primer layer 14, it is preferable to mix another water soluble resin, such as a polyvinyl alcohol based resin, in order to further increase ease of application. The polyvinyl alcohol based resin may be a modified polyvinyl alcohol based resin, such as partially saponified polyvinyl alcohol or completely saponified polyvinyl alcohol, or a carboxyl group modified polyvinyl alcohol, acetoacetyl group modified polyvinyl alcohol, methylol group modified polyvinyl alcohol or amino group modified polyvinyl group. Commercially available products of appropriate polyvinyl alcohol based resins include “KL-318” (trade name), which is an anion group containing polyvinyl alcohol sold by Kuraray Co., Ltd.

In the case where the primer layer 14 is formed of an application liquid including a water soluble epoxy resin, it is preferable that the concentration of the epoxy resin is within a range of approximately 0.2 to 1.5 parts by weight per 100 parts by weight of water. In addition, in the case where a polyvinyl alcohol based resin is mixed with the application liquid, it is preferable that the amount is approximately 1 to 6 parts by weight per 100 parts by weight of water. It is preferable that the thickness of the primer layer 14 is in a range from approximately 0.1 to 10 μm.

The application method used for the formation of the primer layer 14 is not particularly limited, and known various coating method, such as direct gravure methods, reverse gravure methods, dye coating methods, comma coating methods and bar coating methods, can be used.

The coating retardation layer 15 is formed on the primer layer 14. The coating retardation layer 15 is a layer formed by applying an application liquid having an organic modified clay composite and a binder resin in an organic solvent and then removing the solvent.

Here, the organic modified clay composite is a composite of an organic substance and clay mineral, and concrete examples are composites of a clay mineral having a layer structure and an organic compound which can be dispersed in an organic solvent. As the clay mineral having a layer structure, elements in the smectite group and swelling mica can be cited, and it becomes possible to combine these with an organic compound, due to their cation exchanging performance. Among these, elements in the smectite group have excellent transparency, and thus, are preferably used. Hectorite, montmorillonite and bentonite can be cited as examples of elements belonging to the smectite group. Among these, chemically synthesized elements have little impurity and excellent transparency, and thus are preferable. Particularly preferable is synthesized hectorite having a small particle diameter, because it prevents scattering of visible light.

As organic compounds which can form a composite with clay minerals, compounds which react with oxygen atoms an hydrogen groups in clay minerals, and compounds having ions which can be exchanged with exchangeable cations can be cited, and any which allow the organic modified clay composite to swell or disperse in an organic solvent can be used with no particular limitation, and, concretely, nitrogen containing compounds can be cited. As nitrogen containing compounds, primary, secondary and tertiary amines, and quaternary ammonium compounds can be cited. Among these, quaternary ammonium compounds are preferably used, because cation exchange is easy.

Two or more organic modified clay composites can be combined for use. Commercial products of appropriate organic modified clay composites include composites of synthetic hectorite and quaternary ammonium compounds sold under the trade names: “Lucentite STN” and “Lucentite SPN,” by CO-OP Chemical Co., Ltd., respectively.

These organic modified clay composites which can disperse in an organic solvent are combined with a binder resin for use from the viewpoint of such as making coating on the primer layer 14 easier, expressing the optical properties, and physical properties. Binder resins which can be used together with the organic modified clay composite dissolve in organic solvents, such as toluene, xylene, acetone and ethyl acetate, and have a glass transfer temperature of room temperature or lower (approximately 20° C. or less), and thus are preferably used. In addition, it is preferable that the binder resin has hydrophobic properties, in order to provide good moisture-proofness, resistance to heat and ease of handling that are needed when applied to the liquid crystal display. As such preferable binder resins, aldehyde modified polyvinyl alcohol based resins, such as polyvinyl butyral, polyvinyl formal and polyvinyl acetal, cellulose based resins, such as cellulose acetate butyrate, acryl based resins, such as butyl acrylate, urethane resins, methacryl based resins, epoxy resins and polyester resins can be cited.

Commercially available products of appropriate binder resins include aldehyde modified resins of polyvinyl alcohol sold under the trade name: “Denka Butyral #3000-K,” by Denki Kagaku Kogyo K. K., acryl based resins sold under the trade name: “Aron S1601,” by Toagosei Co., Ltd., and isophorone diisocyanate based urethane resins sold under the trade name: “SBU Lacquer 0866,” by Sumika Bayer Urethane Co., Ltd.

It is preferable that the weight ratio of the organic modified clay composite which can be dispersed in an organic solvent to the binder resin is in a range of 1.2 to 10:1, more preferably in a range of 1:1 to 2:1, from the viewpoint of improving the physical properties, such as prevention of the coating retardation layer 15 made of the organic modified clay composite and the binder resin from cracking.

The organic modified clay composite and the binder resin are applied on the primer layer 14 in such a state as to be contained in an organic solvent. At this time, the binder resin is generally dissolved in the organic solvent, and the organic modified clay composite is dispersed in the organic solvent. Though the solid concentration in this dispersion liquid is not particularly limited, as long as the dispersion liquid after preparation does not turn into gel or become clouded in a range causing no problems when practically used, and the total solid concentration of the organic modified clay composite and the binder resin used is usually in a range from approximately 3 to 15% by weight. The optimal solid concentration differs depending on the type of organic modified clay composite and binder resin used, as well as the composition ratio of the two, and therefore, is set for each composition. In addition, various types of additives, such as viscosity adjusting agents for increasing the ease of application at the time of film formation and cross linking agents for further improving the hydrophobic properties and/or duration may be added.

It is preferable that the chlorine content in the application liquid for forming the coating retardation layer 15 which contains the organic modified clay composite and the binder resin in an organic solvent is 2000 ppm or less. In many cases, a compound containing chlorine is contaminated in the organic modified clay composite as an impurity, due to the materials used for the manufacture. When the organic modified clay composite is used with great amounts of the chlorine composite, there is a possibility that chlorine in the retardation layer 15 may bleed out from the film after being coated. In this case, the adhesiveness greatly lowers overtime when the composite polarizing plate is pasted to the glass of a liquid crystal cell with an adhesive layer interposed therebetween. Therefore, it is preferable that a chlorine compound is be removed from the organic modified clay composite through washing, and when the chlorine content is 2000 ppm or less, the adhesiveness can be prevented from lowering. The chlorine compound can be removed in accordance with a method for washing the modified organic clay composite with water.

In addition, it is preferable for the water content of the application liquid for a coating retardation layer as measured using a Karl Fischer's moisture meter to be in a range from 0.15 to 0.35% by weight. In the case where the water content exceeds 0.35% by weight, the phases separate in the non-water soluble organic solvent, and thus, the application liquid tends to separate into two layers. Meanwhile, when the water content is less than 0.15% by weight, the haze value tends to be higher when a coating retardation layer is formed. Methods for measuring the moisture include drying methods, Karl Fischer's method and dielectric constant methods, and here, Karl Fischer's method, according to which a microscopic amount can be easily measured, is adopted.

Though the method for adjusting the water content of the application liquid for the coating retardation layer to within the above described range is not particularly limited, methods for adding water to the application liquid are simple and desirable. The water content is seldom 0.15% by weight or more when an organic solvent, an organic modified clay composite and a binder resin as in the present invention are mixed in accordance with a conventional method. Therefore, it is preferable to set the water content within the above described range by adding a small amount of water to the application liquid gained by mixing an organic solvent, an organic modified clay composite and a binder resin. Methods for adding water are effective at any time during the process for preparing the application liquid, and there are no particular limitations, but methods for adding a predetermined amount of water after the water content of a sample is measured after a certain period of time has elapsed during the process for preparing the application liquid are preferable, because the water content can be adjusted with high reproducibility and high precision. Here, in some cases, the amount of water added does not coincide with the results of measurement using a Karl Fischer's moisture meter. This is considered to be because some of the water interacts with the organic modified clay composite (is adsorbed, for example). However, the haze value of the gained coating retardation layer can be kept low when the moisture ratio as measured using a Karl Fischer's moisture meter is kept at 0.15 to 0.35% by weight.

The application method used to form the coating retardation layer 15 is not particularly limited, and any well known coating method, such as direct gravure methods, reverse gravure methods, dye coating methods, comma coating methods and bar coating methods, can be used.

The anisotropy of the retardation layer 15 in the index of refraction in the thickness direction can be represented by the retardation value Rth in the thickness direction as defined in the above formula (II), and this value can be calculated from the retardation value R40 as measured when inclined by 40 degrees relative to the slow axis in a plane, which is an axis of inclination, and the retardation value R0 in a plane. That is to say, the retardation value Rth in the thickness direction in the formula (II) can be calculated by finding nx, ny and nz through numeral calculation using the following formulas (III) to (V), using the retardation value R0 in a plane, the retardation value R40 as measured when inclined by 40 degrees relative to the slow axis in a plane, which is an axis of inclination, the thickness of the film d and the average index of refraction of the film n0, and substituting these in the above described formula (II).

R0=(nx−ny)×d (III)

R40=(nx−ny′)×d/ cos(φ) (IV)

(nx+ny+nz)/3=n0 (V)

where

φ=sin−1[sin(40°)/n0]

ny′=ny×nz/[ny2×sin 2(φ)+nz2×cos 2 (φ)]1/2

It is preferable that an appropriate value within a range of approximately 40 to 300 nm is selected for the retardation value Rth of the retardation layer 15 in the thickness direction in accordance with the application, particularly the properties of the liquid crystal cell. It is advantageous that the retardation value Rth in the thickness direction is no less than 50 nm and no more than 200 nm.

The polarizer 11 and the transparent protective film 12, as well as the polarizer 11 and the transparent resin film 13, may be joined with an adhesive layer interposed therebetween. The adhesive used in the adhesive layers may be any transparent adhesive. As examples of appropriate adhesives, solutions of polyvinyl alcohql based resins generally used in the art can be cited. The polyvinyl alcohol based resins cited in the above with relation to the primer layer 14 can also be cited as the polyvinyl alcohol based resin. The solutions containing a water soluble epoxy resin and a polyvinyl alcohol based resin cited in the above as examples of the application liquid for forming the primer layer 14 can also be used herein as the adhesive.

In addition, in the case where the resin retardation plate 115 and the polarizer 11 are joined, they may be joined with a tackifier layer 18 interposed therebetween as an adhesive layer. The tackifier layer 18 is also referred to as pressure sensitive adhesive, and can be made of an acryl based polymer, a silicone based polymer or other polymers using polyester, polyurethane, polyether or the like as the base. Among these, it is preferable to select and use a tackifier as an acryl based tackifier having excellent optical transparency, appropriate wettability, cohesive force, excellent adhesiveness with the base, weather resistance and heat resistance, which does not cause any problems such as lifting or peeling under high temperature and high humidity conditions. Acryl based copolymers having a weight average molecular weight of 100,000 or higher into which an alkyl ester of acrylic acid having an alkyl group having a carbon number of 20 or less, for example a methyl group, an ethyl group or a butyl group, and a functional group containing acryl based monomer made of (meth) acrylic acid or hydroxyethyl (meth)acrylate are mixed so that the glass temperature becomes 25° C. or lower, preferably 0° C. or lower, are useful as base polymers for the acryl based tackifier.

The tackifier layer 18 can be formed in accordance with a method for applying a tackifier solution of which the main body is a base polymer, as described above, and drying it, or a method for preparing a film on which a mold release process is carried out and a tackifier layer is formed (film having tackifier) and pasting it on the surface of the coating retardation layer 15 on the tackifier side.

The tackifier layer 18 which can be formed on the coating retardation layer 15 if necessary is the same as in the above.

Next, the method for producing a composite polarizing plate according to the present invention is described. As described abover the composite polarizing plate according to the present invention can be produced through the following steps:

a primer layer forming step for providing a primer layer 14 on the surface of a transparent resin film 13;

a coating retardation layer forming step for applying an application liquid containing an organic modified clay composite and a binder resin in an organic solvent onto the surface of the primer layer 14 and removing the solvent therefrom so that a coating retardation layer 15 is formed; and

a pasting step for separately preparing a polarizer 11 and a transparent protective film 12, and pasting the transparent protective film 12 to one side of the polarizer 11 with an adhesive interposed therebetween and pasting the transparent resin film 13 on which the above described coating retardation layer 15 is formed on the other side of the polarizer 11 with an adhesive interposed therebetween.

After that, a tackifier layer 18 for pasting to a liquid crystal cell or the like can be provided on the outside of the coating retardation layer 15. In the case where a tackifier layer 18 is provided on the outside of the coating retardation layer 15, this tackifier layer 18 can be provided at the end of any of the above described steps, for example, the coating retardation layer forming step, or after all the steps and after the manufacture of the composite polarizing plate.

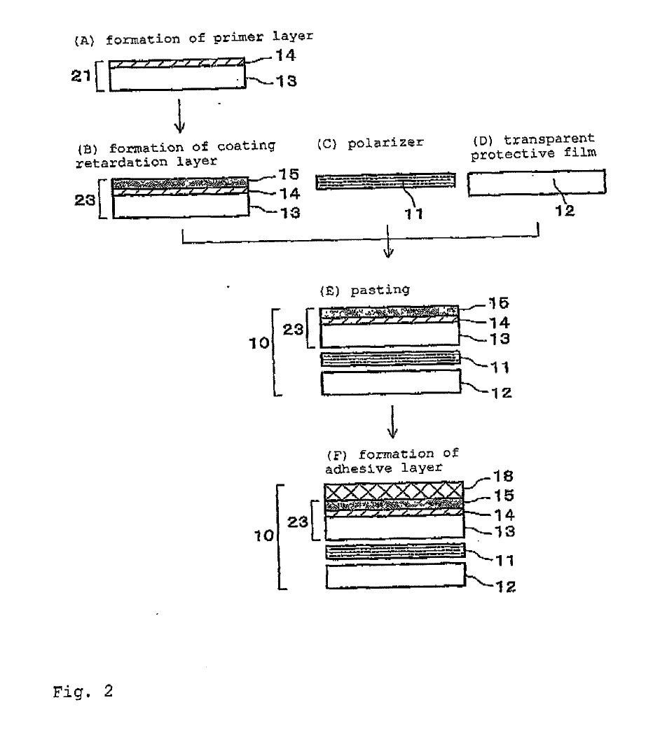

An example of this manufacturing method is divided into each step and used members and shown in the schematic cross sectional diagram of FIG. 2. First, in the primer layer forming step as shown in FIG. 2(A), a primer layer 14 is formed on the surface of a transparent resin film 13 so as to provide a transparent resin film 21 with a primer layer. At this time, it is desirable to saponify the surface of the transparent resin film 13 with an alkali solution. After that, in the coating retardation layer forming step as shown in FIG. 2(B), a coating retardation layer 15 is formed on the surface of the primer layer 14 so as to provide a transparent resin film 23 with a coating retardation layer. Next, in the pasting step, a polarizer 11 as shown in FIG. 2(C) and a transparent protective film 12 as shown in FIG. 2(D) are prepared, and the transparent protective film 12 is pasted to one side of the polarizer 11 with an adhesive interposed therebetween and the transparent resin film 23 with a coating retardation layer is pasted on the other side of the polarizer 11 with an adhesive interposed therebetween as shown in FIG. 2(E), and thus a composite polarizing plate 10 is gained. Furthermore, as shown in FIG. 2(F), a tackifier layer 18 can be formed on the outside of the coating retardation layer 15 if necessary.

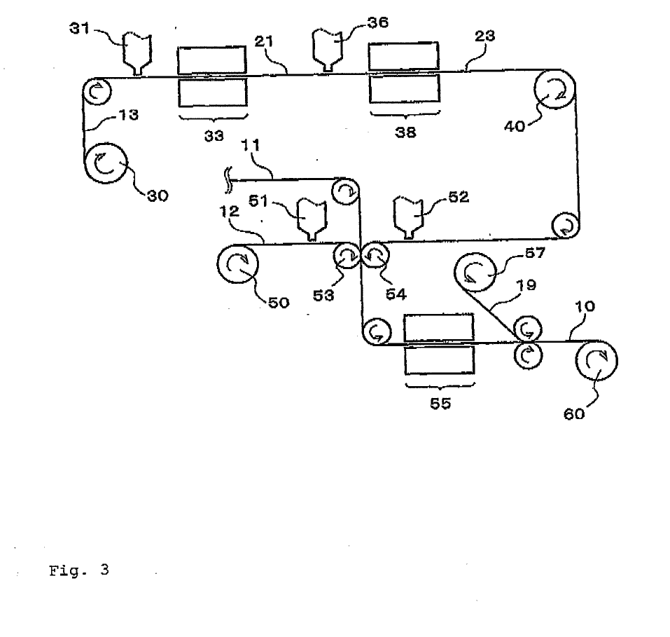

An example of a case where a composite polarizing plate in roll form is manufactured in accordance with this method is shown in the schematic cross sectional diagram of FIG. 3. In this example, first, an application liquid for a primer layer is applied to the surface of the transparent resin film 13 fed out from a roller 30 for feeding out the transparent resin film using a primer layer applicator 31, and subsequently the film is dried when passing through the primer layer drying zone 33, and after that is subjected to the formation of a coating retardation layer. That is to say, an application liquid for a retardation layer is applied to the surface of the primer layer on the transparent resin film 21 with a primer layer [see FIG. 2(A)] using a coating layer applicator 36, and subsequently this is dried when passing through the coating layer drying zone 38, and thus a transparent resin film 23 with a coating retardation layer is gained [see FIG. 2(B)], The film passes through a roller 40 in this state, and after that is subjected to pasting with a polarizer.

In the pasting step, the transparent protective film 12 fed out from the feeding roller 50 is pasted to one side of the polarizer 11 sent through the polarizer producing line, not shown, and the transparent resin film 23 with a coating retardation layer after passing through the previous roller 40 is pasted to the other side of the polarizer 11 on the transparent resin film side (on the side opposite to the coating retardation layer). Prior to pasting, an adhesive is applied to the surface of the transparent protective film 12 and the surface of the transparent resin film 23 with a coating retardation layer on the transparent resin film side using adhesive applicators 51 and 52 respectively. In addition, the films and the polarizer are pasted together using pasting rollers 53 and 54 in such a state that the polarizer 11 is sandwiched between the transparent protective film 12 and the transparent resin film 23 with a coating retardation layer from both sides. Subsequently, this is dried when passing through the polarizing plate drying zone 55, and after that the film 19 with a tackifier fed out from the feeding out roller 57 (a mold release film on which a tackifier layer is provided as described above) is pasted to the coating retardation layer on the tackifier layer side so as to provide a composite polarizing plate 10 with a tackifier, which is then wound up around a product roller 60.

Though FIG. 3 shows an example of a continuous line for producing a composite polarizing plate with a tackifier, this line can be divided into an appropriate number of pieces if necessary. A transparent resin film 23 with a coating retardation layer can be once wound up around a roller in a stage where a primer layer and a coating retardation layer are formed on the transparent resin film in this order, for example. In addition, a transparent resin film 21 with a primer layer can be once wound up around a roller in a stage where a primer layer is formed on a transparent resin film before the above described transparent resin film 23 with a coating retardation layer is gained, for example. Furthermore, a composite polarizing plate is once wound up around a roller before a tackifier layer is provided, and after that the tackifier layer can be provided in a subsequent different step.

Here, in FIG. 3, circular arrows indicate the direction in which a roller rotates. In addition, though the tackifier layer is shown in a state where the film 20 with a tackifier is pasted to apolarizer on the tackifier layer side, a tackifier layer can be provided in accordance with a method for applying a tackifier application liquid.

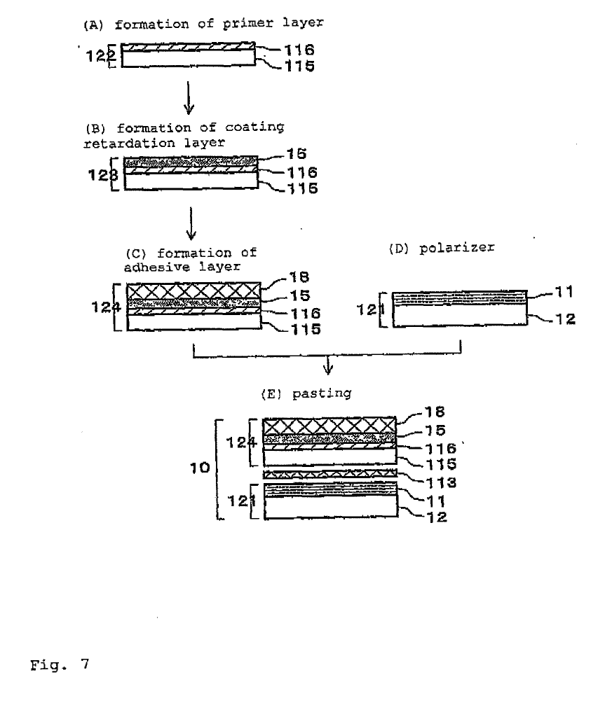

In addition, examples of cases where the above described transparent resin film is a resin retardation plate and where a tackifier layer 18 is provided at the end of the coating retardation layer forming step is shown in schematic cross sectional diagrams in FIG. 7, where the production method is divided into each step and members used. First, in the primer layer forming step, as shown in FIG. 7(A), a primer layer 116 is formed on the surface of a resin retardation plate 115, and thus, a retardation plate with a primer layer 122 is gained. At this time, it is preferable to carry out a corona discharge process on both sides of the resin retardation plate 115. Next, in the coating retardation layer forming step, as shown in FIG. 7(B), a coating retardation layer 15 is formed on the surface of the primer layer 116, and thus, a laminated retardation plate 123 is gained. After that, as shown in FIG. 7(C), a tackifier layer 18 is formed on the surface of the coating retardation layer 15, and thus, a laminated retardation plate 124 with a tackifier layer is gained. Furthermore, in the pasting step, a polarizing plate 121 where a transparent protective film 12 is pasted to one side of a polarizer 11 as shown in FIG. 7(D) is prepared, and as shown in FIG. 7 (E), the retardation plate 115 side of the laminated retardation plate 124 with a tackifier layer (laminated retardation plate 123 in case where no retardation layer 18 provided) and the polarizer 11 side of the polarizing plate 121 are pasted together with an adhesive layer 113 interposed therebetween, and thus, a composite polarizing plate 10 is gained.

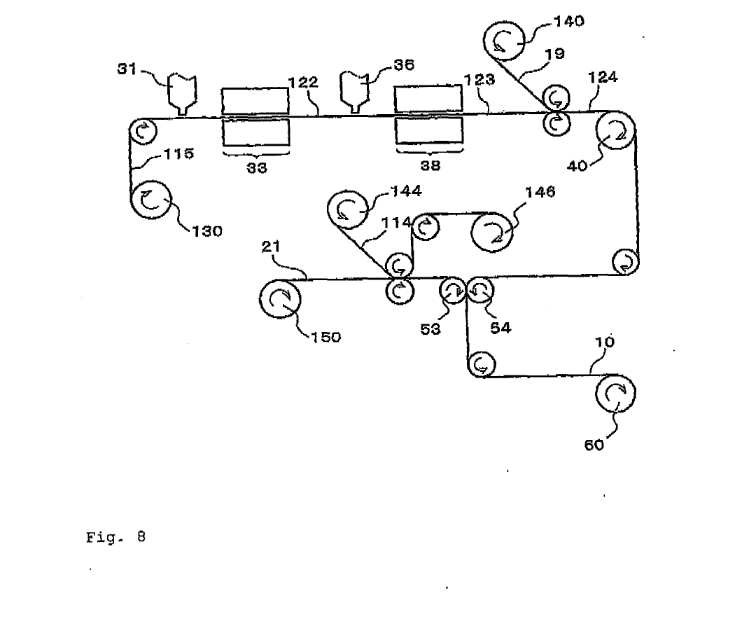

An example of a case where a composite polarizing plate in roll form is produced in the above state is shown in the schematic cross sectional diagram of FIG. 8.

In this example, first an application liquid for a primer layer is applied on the surface of the retardation plate 115 fed out from the roller 30 for feeding out a retardation plate using a primer layer applicator 31, and next the plate is dried as it passes through a primer layer drying zone 33, and after that, subjected to formation of a coating retardation layer. In this case also, it is preferable that the retardation plate 115 is subjected to a corona discharge process on both sides. Next, an application liquid for a retardation layer is applied on the surface of the primer layer on the retardation plate with a primer layer 122 [see FIG. 7 (A)] using a coating layer applicator 36, and subsequently the plate is dried as it passes through a coating layer drying zone 38, and thus, a interposed therebetween retardation plate 123 is gained [see FIG. 7 (B)]. After that, this interposed therebetween retardation plate 123 is subjected to pasting with a tackifier 19. Here, the film with a tackifier 19 is a mold release film on which a tackifier layer is provided, and the film with a tackifier 19 fed out from the roller 140 for feeding out a film with a tackifier is supplied on the surface of the coating retardation layer of the laminated retardation plate 123, and thus the filrm is pasted on the coating retardation layer on the tackifier layer side, and when the two are pasted together, a laminated retardation plate with a tackifier layer 124 is gained. This passes through a roller 40 in this state, and after that is subjected to pasting to a polarizing plate.

In the pasting step, first a film with an adhesive 114 fed out from a roller for feeding out a film 144 is supplied to the polarizer side of a polarizing plate 121 fed out from another roller for feeding out a film 150 (a transparent protective film is pasted on one side of the polarizer, as described in reference to FIG. 6) so that the film is pasted to the plate on the adhesive layer side, and thus, the adhesive is pasted on the polarizer. Here, the film with an adhesive 114 is the mold release film on which an adhesive layer 13 is provided as described above in reference to FIG. 6. After an adhesive layer is pasted to the polarizer on the polarizing plate 121, the mold release film is removed and wound around a roller for winding amold release film 146. Then, the adhesive layer on the polarizing plate 121 on which the adhesive layer is formed is pasted on the resin retardation plate side of the laminated retardation plate with a tackifier layer 124, after the laminated retardation plate passes through the above described roller 40, using pasting rollers 53 and 54, and thus, a composite polarizing plate l0 is gained as a product. After that, the composite polarizing plate 10 is wound around the product roll 60.

FIG. 8 shows an example where the composite polarizing plate with a tackifier 10 is gained in a continuous line, which can be divided into an appropriate number of pieces if necessary. The laminated retardation plate 123 where a primer layer and a coating retardation layer are formed on the retardation plate 115 in this order or a laminated retardation plate with a tackifier layer 124 where a tackifier layer is formed on the laminated phase plate on the coating retardation layer side can be wound around a roller once, for example. In addition, the retardation plate with a primer layer 122 where a primer layer is formed on the retardation plate 115 can be roller around a roller once before the above described lamiminated retardation plate 123 is gained, for example.

Here, in FIG. 8, the circular arrows indicate the direction in which the rollers rotate. In addition, though tackifier layers and adhesive layers gained by pasting a film with a tackifier 19 or a film with an adhesive 114 on the tackifier layer side or the adhesive layer side are shown, a tackifier layer or adhesive layer can be provided in accordance with a method according to which a tackifier application liquid or an adhesive application liquid is applied.

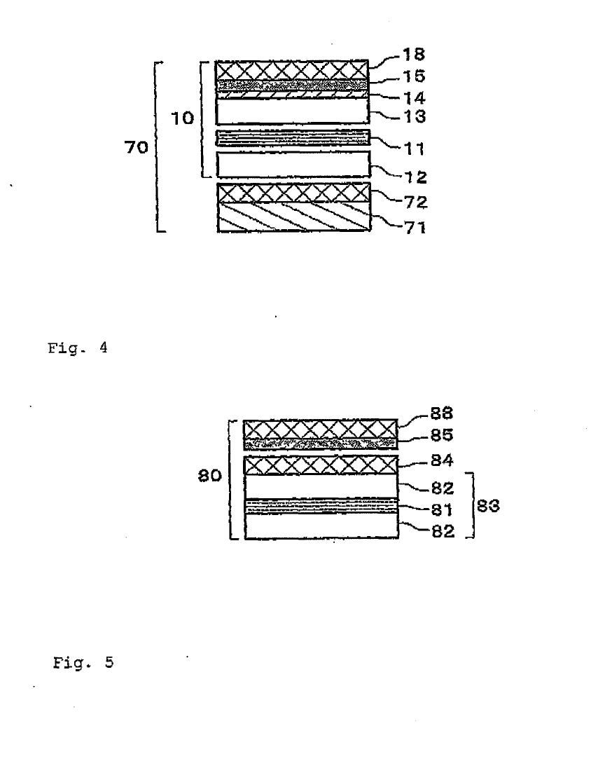

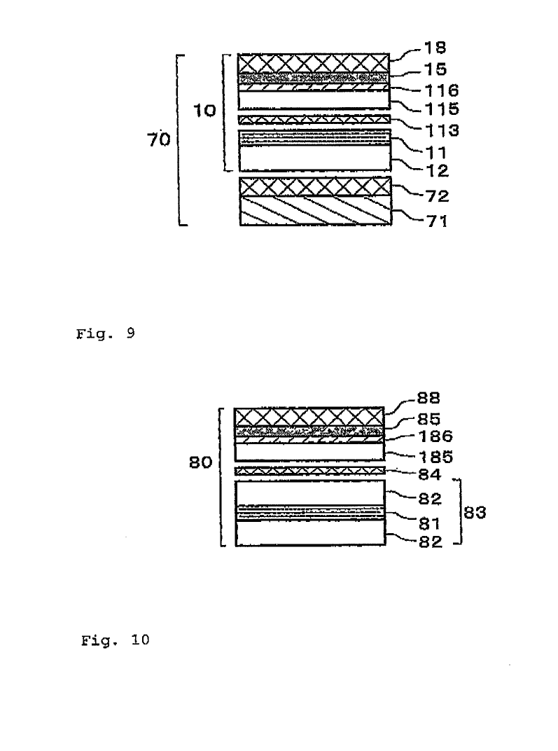

The composite polarizing plate gained as described above can be laminated on an optical layer having other optical properties, and thus, a composite optical member can be gained. An example of the layer structure of a composite optical member is shown in the schematic cross sectional diagrams of FIGS. 4 and 9.

In this example, an optical layer 71 having other optical properties is laminated on the transparent protective film 12 side in the composite polarizing plate 10 shown in FIGS. 1 and 6, and thus, a composite optical member 70 is gained. For example, tackifier can be used in the both laminated layers and FIGS. 4 and 9 show this as the tackifier layer 72. A brightness increasing film conventionally used for the formation of liquid crystal displays and the like can be cited as an example of the optical layer 71 having other optical properties. The brightness increasing film is an optical film which can increase the efficiency of the backlight when used in a liquid crystal display. As examples of the brightness increasing film, “DBEF,” which is a reflective polarization separating film sold by Minnesota Mining and Manufacturing Company (3M Company) [Sumitomo 3M Limited in Japan] and “BEF,” which is an upward facing prism sheet sold by 3M corporation, can be cited. In the case where a tackifier is used to paste another optical layer 71, the same tackifier as for the tackifier layer 18 described above in reference to FIG. 1 can be used.

In addition, a layer having other optical properties, for example a uniaxial or biaxial retardation plate, can be provided outside the tackifier layer 18 in the composite polarizing plate 10 shown in FIG. 1. In this case, another tackifier layer is usually provided on the outside, and a retardation plate with a tackifier layer may be laminated on the outside of the tackifier layer 18 of the composite polarizing plate 10 shown in FIG. 1, so that the tackifier layer faces outward, for example.

The composite polarizing plate 10 shown in FIGS. 1 and 6 and the composite optical member 70 shown in FIGS. 4 and 9 can be used in a liquid crystal display when provided on at least one side of a liquid crystal cell. A composite polarizing plate 10 can also be provided on both sides of a liquid crystal cell. In addition, a composite polarizing plate 10 can be placed on one side of a liquid crystal cell and a composite optical member 70 provided on the other side. A composite polarizing plate 10 or a composite optical member 70 is provided on one side of a liquid crystal cell, and another polarizing plate can be provided on the other side with a retardation plate interposed therebetween if necessary. Though it is preferable for a liquid crystal cell to be of a vertical alignment (VA) mode, as described in Background Art, the composite polarizing plate for the composite optical member according to the present invention functions effectively for liquid crystal cells in other systems, such as of bend orientation (ECB) modes.

Though in the following, the present invention is described in further detail in reference to examples, the present invention is not limited to these examples. In the examples, % and parts representing the content and amount of use are based on by weight unless otherwise stated. The compositions of the application liquid for a primer layer and the application liquid for a retardation layer used in the following examples are as follows, respectively.

### [Application Liquid For Primer Layer]

Those in which “Sumnirez Resin 650 (30)” (trade name; solution with a solid concentration of 30%) which is a polyamide epoxy resin made by Sumitomo Chemtex Co., Ltd., was used as a water soluble epoxy resin, and “KL-318” (trade name) which is an anion group containing polyvinyl alcohol made by Kuraray Co., Ltd., was used as a polyvinyl alcohol based resin, and the two were mixed in the following composition.

### Composition of Application Liquid For Primer Layer:

| | |
|---|---|
| water | 100 parts |
| polyamide epoxy resin: “Sumirez Resin 650 (30)” | 1.5 parts |
| anion group containing polyvinyl alcohol: “KL-318” | 3 parts |

This application liquid was prepared by mixing water with polyvinyl alcohol: “KL-328” while heating the whole to 100° C., and cooling this to room temperature after stirring, and then mixing it with a polyamide epoxy resin: “Sumirez Resin 650 (30),” followed by stirring. Application liquids prepared in this manner can be used as a pasting transparent protective film, a polarizer, or an adhesive for pasting transparent protective films and polarizers together.

### [Application Liquid For Retardation Layer]

Those in which “Lucentite STN” (trade name), made by CO-OP Chemical co., Ltd., which is a composite of synthetic hectorite and trioctyl methyl ammnonium ions, was used as an organic modified clay composite, and “SBU Lacquer 0866” (trade name), made by Sumika Bayer Urethane Co., Ltd., which is an isophorone diisocyanate based polyurethane resin and a resin varnish having a solid concentration of 30%, was used as a binder resin, and these were mixed in the following composition.

### Composition of Application Liquid For Retardation Layer:

| | |
|---|---|
| urethane resin varnish: “SBU Lacquer 0866” | 16.0 parts |
| organic modified clay composite: “Lucentite STN” | 7.2 parts |
| toluene | 76.8 parts |
| water | 0.3 parts |

The organic modified clay composite used here was gained in such a state as to be washed with acid after the production of synthetic hectorite before being modified with an organic substance, and then modified with an organic substance, followed by washing with water by the manufacturer. The amount of chlorine contained inside was 1111 ppm. In addition, this application liquid was prepared by mixing the materials in the above described composition and filtering this through a filter having pores with a diameter of 1 μm after stirring, and the water content was 0.25% as measured using a Karl Fischer's moisture meter. The solid weight ratio of organic modified clay composite/binder resin in the application liquid was 6/4.

### Example 1

### (a) Formation of Retardation Layer

The above described application liquid for a primer layer was applied to one side of a transparent resin film having a thickness of 40 μm and being made of triacetyl cellulose on both sides of which a saponification process was carried out, and this was dried for approximately one minute at 80° C., and thus a primer layer having a water content of approximately 20% was formed. Next, the above described application liquid for a retardation layer was applied on top of this primer layer, and after that this was dried for three minutes at 90° C., and thus a coating retardation layer was formed.

### (b) Fabrication of Polarizer

A polyvinyl alcohol film having a thickness of 75 μm, an average polymerization degree of approximately 2400 and a saponification degree of 99.9 mol % or higher was uniaxially stretched to a size approximately five times greater in a dry system, and furthermore immersed in pure water at 60° C. while maintaining a tense state, and after that was immersed in a solution where the weight ratio of iodine/potassium iodide/water was 0.05/5/100 at 28° C. for 60 seconds. After that, the film was immersed in a solution where the weight ratio of potassium iodide/boric acid/water was 8.5/8.5/100 at 72° C. for 300 seconds. Subsequently, the film was washed with pure water at 26° C. for 20 seconds, and after that dried at 65° C., and thus a polarizer where oriented iodine was adsorbed in polyvinyl alcohol was gained.

### (c) Fabrication of Composite Polarizing Plate

The laminated film made of triacetyl cellulose film/primer layer/coating retardation layer fabricated in the above (a) was pasted to one side of the polarizer gained in the above (b) on the triacetyl cellulose film side with an adhesive interposed therebetween, and a triacetyl cellulose film was pasted to the other side of the polarizer with an adhesive interposed therebetween, and thus a composite polarizing plate was fabricated. That is to say, the above described application liquid for a primer layer was applied to the surface of the laminated film made of triacetyl cellulose film/primer layer/coating retardation layer fabricated in the above (a) on the triacetyl cellulose film side and to the surface on which a saponification process was carried out of the transparent protective film having a thickness of 40 μm and being made of triacetyl cellulose on the sides of which a saponification process was carried out, and each of them was pasted to the polarizer gained in the above (b) on the application layer side, and this was dried at 80° C. for seven minutes. After that, an acryl based tackifier [“P-3132” made by Lintec Corporation] was pasted to the surface on the coating retardation layer side, and thus a composite polarizing plate where a transparent protective film, apolarizer, a transparent resin film, a primer layer, a coating retardation layer and a tackifier layer were laminated in this order was gained. The layer structure of the composite polarizing plate fabricated in this example is shown in FIG. 1.

### (d) Measurement of Thickness of Composite Polarizing Plate

The composite polarizing plate with a tackifier layer gained in (c) was cut into pieces having a width of 25 mm and a length of approximately 850 mm, and thicknesses at nine points were measured in the direction of the length using a digital length measuring machine “MH-15M” made by Mikon Corporation. The results of the averages of the nine points are shown in Table 1.

### (e) Optical Performance Evaluation of Composite Polarizing Plate

The composite polarizing plate with a tackifier layer gained in (c) was cut into a 25 mm square, and this was pasted to soda glass on the tackifier layer side, and after that a pressure applying process was carried out in an autoclave for 20 minutes at a pressure of 5 kgf/cm² and a temperature of 50° C., and then the retardation value in the thickness direction, the degree of polarization and the haze value were measured in the following methods, and thus the results are shown in Table 1.

(e1) Retardation Value in Thickness Direction:
Measured using a retardation measuring device “KOBRA-WR” made by Oji Scientific Instruments Co., Ltd.
(e2) Degree of Polarization:
Measured using a spectrometer “UV-2400” made by Shimadzu Corporation.
(e3) Haze Value:
Measured using a haze meter “HZ-1” made by Suga Test Instruments Co., Ltd.

### Comparative Example 1

### (a) Fabrication of Composite Polarizing Plate

The above described application liquid for a retardation layer was applied to the surface on which a mold release process was carried out of a polyethylene terephthalate film having a thickness of 38 μm on which a mold release process was carried out (angle of contact of the surface on which mold release process was carried out with water: 110°), and after that this was dried for three minutes at 90° C., and thus a coating retardation layer was formed. A coating retardation layer formed on the above described polyethylene terephthalate film was pasted to a separately prepared polarizing plate with a tackiffier “SRW062AP6-HC2,” made by Sumitomo Chemical Co., Ltd. (a polarizer where oriented iodine was adsorbed in polyvinyl alcohol was sandwiched with triacetyl cellulose films having a thickness of 40 μm from the two sides, and a tackifier layer was formed on one side), on the tackifier layer side, and the polyethylene terephthalate film was peeled off, and after that the same acryl based tackifier [“P-3132” made by Lintec Corporation] as that used in Example 1 was pasted to the surface from which the polyethylene terephthalate film was peeled, and thus a composite polarizing plate was gained. The layer structure of the composite polarizing plate gained in this example is shown in the schematic cross sectional diagram of FIG. 5. That is to say, this composite polarizing plate 80 has a layer structure of (polarizing plate 83 where polarizer 81 is sandwiched by triacetyl cellulose films 82, 82 from the two sides)/tackifier layer 84/coating retardation layer 85/tackifier layer 88.

### (b) Measurement of Thickness of Composite Polarizing Plate

The composite polarizing plate with a tackifier layer gained in (a) was cut into pieces having a width of 25 mm and a length of approximately 850 mm, and thicknesses at nine points were measured in the direction of the length using a digital length measuring machine “MH-15M” made by Nikon Corporation. The results of the averages of the nine points are shown in Table 1.

### (c) Optical Performance Evaluation of Composite Polarizing Plate

The composite polarizing plate with a tackifier layer gained in (a) was cut into a 25 mm square, and this was pasted to soda glass on the tackifier layer side, and after that a pressure applying process was carried out in an autoclave for 20 minutes at a pressure of 5 kgf/cm² and a temperature of 50° C., and then the retardation value in the thickness direction, the degree of polarization and the haze value were measured in the samemethods as in (e1) to (e3) of Example 1, and thus the results are shown in Table 1.

It can be seen from the above described results that it is necessary for the requirements defined in the present invention to be satisfied and well-balanced in order to gain the optical properties which are an object of the present invention.

TABLE 1

| | | Optical performance | | |
|---|---|---|---|---|
| | | Retardation value | | |
| | | in thickness | degree of | Haze |
| | Thickness | direction | polarization | value |
| Example 1 | 151 μm | 150.7 nm | 99.99% | 0.2% |
| Comparative | 164 μm | 150.8 nm | 99.98% | 0.2% |
| example 1 | | | | |

### Example 2

### (a) Fabrication of Laminated Retardation Plate

First, a corona discharge process was carried out on the two sides of a retardation plate having a thickness of 28 μm, which is a uniaxially expanded film of a norbornene based resin [“CSES430120Z-S-KY” made by Sumitomo Chemical Co., Ltd., retardation value in plane: 120 nm]. Next, the above described application liquid for a primer layer was applied to one side of the film, and this was dried for approximately one minute at 80° C., and thus a primer layer having a water content of approximately 20% was formed. Next, the above described application liquid for a retardation layer was applied on top of this primer layer, and after that this was dried for three minutes at 90° C., and thus a coating retardation layer was formed. Subsequently, an acryl based tackifier [“P-3132” made by Lintec Corporation] was pasted to this coating retardation layer, and thus a laminated retardation plate where a resin retardation plate, a primer layer, a coating retardation layer and a tackifier layer were laminated in this order was gained.

### (b) Fabrication of Composite Polarizing Plate

A polarizing plate where a transparent protective film having a thickness of 40 μm made of triacetyl cellulose was pasted to one side of a polyvinyl alcohol-iodine based polarizer [“SR066A-HC” made by Sumitomo Chemical Co., Ltd.] was separately prepared, and a tackifier [L1 made by Lintec Corporation] was applied to the surface which did not have the transparent protective film, and the above described laminated retardation plate was pasted on top of that on the resin retardation plate side, and thus a composite polarizing plate with a tackifier layer was gained. The layer structure of the composite polarizing plate fabricated in this example is shown in FIG. 6.

### (c) Measurement of Thickness of Composite Polarizing Plate

The composite polarizing plate with a tackifier layer fabricated in the above (b) was cut into pieces having a width of 25 mm and a length of approximately 850 mm, and thicknesses at nine points were measured in the direction of the length using a digital length measuring machine “MH-15M” made by Nikon Corporation. The results of the averages of the nine points are shown in Table 2.

### (d) Optical Performance Evaluation of Composite Polarizing Plate

The composite polarizing plate with a tackifier layer fabricated in the above (b) was cut into a 25 mm square, and this was pasted to soda glass on the tackifier layer side, and after that a pressure applying process was carried out in an autoclave for 20 minutes at a pressure of 5 kgf/cm² and a temperature of 50° C., and then the retardation value in the thickness direction, the degree of polarization and the haze value were measured in the following methods, and thus the results are shown in Table 2.

(d1) Retardation Value in Direction of Thickness:
Was measured using a retardation measuring device “KOBRA-WR” made by Oji Scientific Instruments Co., Ltd.
(d2) Degree of Polarization:
Was measured using a spectrometer “UV-2400” made by Shimadzu Corporation.
(d3) Haze Value:
Was measured using a haze meter “HZ-1” made by Suga Test Instruments Co., Ltd.

### Comparative Example 2

### (a) Fabrication of Composite Polarizing Plate

A separately prepared polarizing plate with a tackifier “SRW062AP6-HC2,” made by Sumitomo Chemical, Co., Ltd. (a polarizer where oriented iodine was adsorbed in polyvinyl alcohol was sandwiched by triacetyl cellulose films having a thickness of 40 μm from the two sides, and furthermore a tackifier layer was formed on one side), was pasted to the resin retardation plate side of the laminated retardation plate fabricated in (a) of Example 2 on the tackifier layer side, and thus a composite polarizing plate with a tackifier layer was fabricated. The layer structure of the composite polarizing plate gained in this example is shown in the schematic cross sectional diagram of FIG. 10. That is to say, this composite polarizing plate 180 has a layer structure of triacetyl cellulose film 82/polarizer 81/triacetyl cellulose film 82/tackifier layer 84/resin retardation plate 185/primer layer 186/coating retardation layer 85/tackifier layer 88.

### (b) Measurement of Thickness of Composite Polarizing Plate

The composite polarizing plate with a tackifier layer fabricated in the above (a) was cut into pieces having a width of 25 mm and a length of approximately 850 mm, and thicknesses at nine points were measured in the direction of the length using a digital length measuring machine “MH-15M” made by Nikon Corporation. The results of the averages of the nine points are shown in Table 2.

### (c) Optical Performance Evaluation of Composite Polarizing Plate

The composite polarizing plate with a tackifier layer fabricated in the above (a) was cut into a 25 mm square, and this was pasted to soda glass on the tackifier layer side, and after that a pressure applying process was carried out in an autoclave for 20 minutes at a pressure of 5 kgf/cm² and a temperature of 50° C., and then the retardation value in the thickness direction, the degree of polarization and the haze value were measured in the same methods as in (d1) to (d3) of Examnple 1, and thus the results are shown in Table 2.

TABLE 2

| | | Optical performance | | |
|---|---|---|---|---|
| | | Retardation value | | |
| | | in thickness | degree of | Haze |
| | Thickness | direction | polarization | value |
| Example 2 | 141 μm | 210.8 nm | 99.97% | 0.2% |
| Comparative | 187 μm | 209.8 nm | 99.98% | 0.2% |
| example 2 | | | | |

As is clear fromn the comparison of the above described examples and comparative examples, the composite polarizing plate according to the present invention can be thinned even further than the conventional products (Comparative Examples 1 and 2) while exhibiting the same optical performance as these.

### INDUSTRIAL APPLICABILITY

The composite polarizing plate according to the present invention can be provided by preparing a transparent resin film on which a primer layer and a coating phase layer are directly formed and pasting this and a transparent protective film on both sides of the polarizer, respectively, and thus can be made thinner than conventional products. Furthermore, a thinner composite polarizing plate than in the prior art can be provided by providing a retardation function to the above described transparent resin film and pasting it to the polarizer with an adhesive layer interposed therebetween. Accordingly, a thinner liquid crystal display than in the prior art can be provided, by applying such a composite polarizing plate or a composite optical member where an optical layer exhibiting another optical function is laminated on such a composite polarizing plate.

1. A composite polarizing plate, wherein a transparent protective film is pasted on one side of a polarizer, and a transparent resin film, a primer layer and a coating retardation layer containing an organic modified clay composite and a binder resin are formed on the other side in this order.

2. The composite polarizing plate according to claim 1, wherein the transparent resin film is a resin retardation plate.

3. (canceled)

4. The composite polarizing plate according to claim 1, wherein the polarizer is a polyvinyl alcohol based resin film which adsorbs oriented dichromatic pigments.

5. The composite polarizing plate according to claim 1, wherein the protective film pasted on one side of the polarizer is made of a cellulose based resin or a polyolefin based resin.

6. The composite polarizing plate according to claim 1, wherein the transparent resin film on which the primer layer is formed is made of a cellulose based resin or a polyolefin based resin.

7. The composite polarizing plate according to claim 1, wherein the primer layer is made of a transparent resin.

8. The composite polarizing plate according to claim 7, wherein the primer layer contains an epoxy resin.

9. The composite polarizing plate according to claim 7, wherein the primer layer is formed of a composition containing a water soluble epoxy resin and a polyvinyl alcohol based resin.

10. The composite polarizing plate according to claim 9, wherein the water soluble epoxy resin is a polyamide epoxy resin.

11. A method for producing a composite polarizing plate, comprising:
a primer layer forming step for providing a primer layer on the surface of a transparent resin film;
a coating retardation layer forming step for applying an application liquid containing an organic modified clay composite and a binder resin in an organic solvent on the surface of the primer layer and forming the coating retardation layer by removing the solvent therefrom; and
a pasting step for separately preparing a polarizer and a transparent protective film and pasting the transparent protective film on one side of the polarizer with an adhesive layer interposed therebetween and pasting the transparent resin film on which said coating retardation layer is formed on the other side of the polarizer with an adhesive layer interposed therebetween.

12. The method for producing a composite polarizing plate according to claim 11, wherein the transparent resin film is a resin retardation plate.

13. The method for producing a composite polarizing plate according to claim 12, wherein the resin retardation plate is oriented in a plane.

14. A composite optical member, wherein an optical layer exhibiting another optical finction is laminated on the composite polarizing plate according to claim 1.

15. A liquid crystal display, wherein the composite polarizing plate according to claim 1 is provided on at least one side of the liquid crystal cell.

16. A liquid crystal display, wherein the composite optical member according to claim 14 is provided on at least one side of the liquid crystal cell.

17. The composite polarizing plate according to claim 9, wherein the resin retardation film is oriented in a plane.
